(19) United States
(12) Patent Application Publication
(10) Pub. No.: US 2010/0122892 A1
(43) Pub. Date: May 20, 2010

(54) REGISTRATION METHOD FOR MULTIWALL PAPER AND WOVEN PACKAGES

(75) Inventor: Clifton R. HOWELL, Buford, GA (US)

Correspondence Address: DAY PITNEY LLP;ACCOUNT: ILLINOIS TOOL WORKS INC., 7 TIMES SQUARE, NEW YORK, NY, 10036-7311, US

(73) Assignee: ILLINOIS TOOL WORKS INC., Glenview, IL (US)

(21) Appl. No.: 12/540,466

(22) Filed: Aug. 13, 2009

Related U.S. Application Data
(60) Provisional application No. 61/115,791, filed on Nov. 18, 2008.

(51) Int. Cl. B65G 47/31

(52) U.S. Cl. 198/460.1

(57) ABSTRACT

The method and apparatus relates to the use of a staging conveyor between an initial conveyor and a main conveyor, such as is used for large multiwall or woven packages or bags. The staging conveyor is driven by a servo which is controlled by a programmable logic controller or similar device. A photo-eye senses the leading of the package or bag after the package or bag is captured within the staging conveyor. The position of the leading edge is fed back to the programmable logic device which then calculates a desired speed of the staging conveyor in order to present the package or bag to the main conveyor at the desired time. The programmable logic device controls the servo so as to achieve the desired speed.

This application claims priority under 35 U.S.C. §119(e) of provisional application Ser. No. 61/115,791 filed Nov. 18, 2008, the contents of which are hereby incorporated by reference.

### BACKGROUND OF THE INVENTION

1. Field of the Invention

The present invention relates to an apparatus and method which uses a separate registration staging drive for registering packages or bags, particularly large multiwall and woven packages or bags, into a machine, such as a main conveyor, that processes such packages or bags.

2. Description of the Prior Art

The prior art of reclosable packages or bags and the manufacture thereof is well-developed and satisfactory for its intended purposes. Some devices in current use employ a lug chain to feed packages or bags in the main conveyor or nip roller with no feedback for registration. Registration is only as accurate as the speed control of the lug and the main conveyor with no consideration to product defects such as wrinkles. Because the lug chain pushes the bag from the trailing edge into a belt conveyor at the leading edge, wrinkles in the package or bag causes registration errors in the belt conveyor.

Large reclosable packages and the methods of manufacture thereof are disclosed in commonly assigned U.S. patent application Ser. No. 11/728,477 entitled “High Burst Zipper Assembly for Large Reclosable Packages”; U.S. patent application Ser. No. 11/728,405 entitled “Method of Producing High Burst Zipper Assemblies for Large Reclosable Packages” and application Ser. No. 11/728,413 entitled “Hot-melt Adhesive Systems for Zipper Assemblies on Large Bag Constructions of Various Substrates”, all filed on Mar. 26, 2007. Similarly, methods for feeding large packages are described in commonly assigned U.S. patent application Ser. No. 11/891,697 entitled “Method for Feeding Large Packages or Bags Into a Reclosable Zipper Profile Attaching Device”, filed on Aug. 13, 2008.

### SUMMARY AND OBJECTS OF THE INVENTION

It is therefore an object of the present invention to improve the registration of packages or bags, particularly large multiwall or woven packages or bags, into a machine that processes the packages or bags.

This and other objects are attained by a method and apparatus which registers large multiwall or woven package or bags into a machine by the use of a separate registration staging device. The packages or bags are placed on a table with chains that have an attachment to drive them into the staging conveyor. After the package or bag is captured by the staging conveyor, its leading edge is sensed by a photo-electric eye. The position of the leading edge is then fed back to a programmable logic controller or similar microprocessor whereby calculations are performed to control the servo whereby the speed of the registration staging device is increased or decreased to present the package or bag into the main machine conveyor at the correct time.

### BRIEF DESCRIPTION OF THE DRAWINGS

Further objects and advantages of the invention will become apparent from the following description and from the accompanying drawing, wherein:

FIG. 1 is a schematic of an embodiment of the present invention.

### DETAILED DESCRIPTION OF THE PREFERRED EMBODIMENT

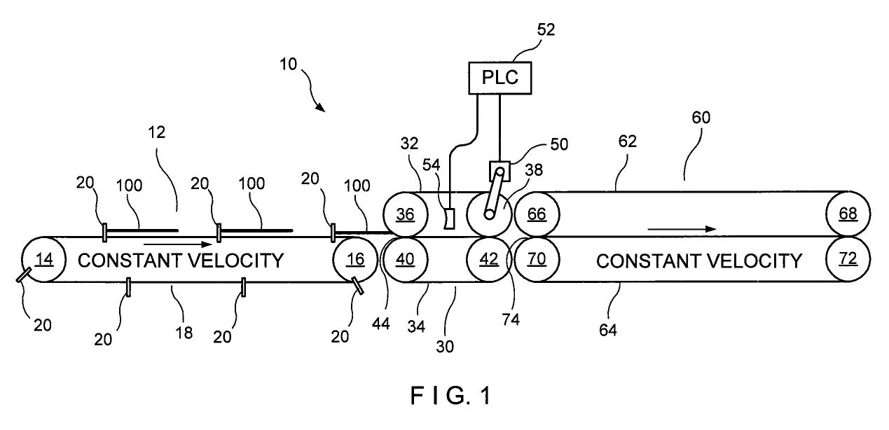

Referring now to the drawings in detail wherein like numerals indicate like elements throughout the several views, one sees that FIG. 1 is a schematic of an embodiment of the registration apparatus 10 of the present invention.

Initial conveyor 12 includes two opposed rollers 14, 16 with lug chains 18 traveling thereon (typically one lug chain proximate to each lateral edge of initial conveyor 12). In the illustration and orientation of FIG. 1, lug chains 18, as well as rollers 14, 16, are traveling in a clockwise orientation, typically at a constant speed. Lug chain 18 includes evenly spaced lugs 20 which engage the trailing edge of successive packages or bags 100. Packages or bags 100 are typically large multiwall paper or woven bags. Those skilled in the art will recognize a broad range of possible contents for the packages 100, including, but not limited to, charcoal, pet food, livestock or other animal food, cat litter, fertilizer, seeds, plant bulbs, rock salt, and foodstuffs.

Initial conveyor 12 successively passes packages or bags 100 to staging conveyor 30. Staging conveyor 30 includes upper and lower belts 32, 34. Upper belt 32 traverses the path defined by first and second upper rollers 36, 38 while lower belt 34 traverses the path defined by first and second lower rollers 40, 42. Nip 44 is formed between upper and lower belts 32, 34 as upper and lower belts 32, 34 pass between first upper roller 36 and first lower roller 40. The lower path of upper belt 32 and the upper path of lower belt 34 impinge against each other so as to engage the packages or bags 100 securely therewithin and to temporarily remove wrinkles from the packages or bags 100 during processing. Second upper roller 38 is illustrated as driven by servo 50, but those skilled in the art will realize, after review of this disclosure, that other rollers could be driven. The movement of second upper roller 38 likewise induces the movement of rollers 36, 40, 42 as well as that of upper and lower belts 32, 34 due to the contact between upper and lower belts 32, 34. Servo 50 is controlled by programmable logic controller (or similar microcomputer or other computing device) 52. Programmable logic controller 52 receives information fed back from photo-electric eye 54 which senses the leading edge of the package or bag after the package or bag 100 is captured within staging conveyor 30 and is passing through the staging conveyor 30. This information is used by the programmable logic controller 52 to adjust (i.e., increase or decrease) the speed of the belts and rollers of the staging conveyor 30 via servo 50 whereby the packages or bags 100 can be introduced into the main conveyor 60 at the correct or desired time, as required by the specifics of the operation of main conveyor 60. The photo-electric eye 54 is illustrated in FIG. 1 as being within the loop formed by upper belt 32, but those skilled in the art will recognize, after review of the disclosure, will recognize that other positions may be desirable to accurately sense the leading edge of the package or bag 100.

Main conveyor (or subsequent conveyor or other similar device) 60 typically includes upper and lower belts 62, 64. Upper belt 62 traverses the path defined by first and second upper rollers 66, 68 while lower belt 64 traverses the path defined by first and second lower rollers 70, 72. Nip 74 is formed between upper and lower belts 62, 64 as upper and lower belts 62, 64 pass between first upper roller 66 and first lower roller 70. The lower path of upper belt 62 and the upper path of lower belt 64 impinge against each other so as to engage the packages or bags 100 securely therewithin. The speed of the upper and lower belts 62, 64 and rollers 66, 68, 70, 72 is typically constant, and may be either the same or different as the speed of the initial conveyor 12

By way of the control of the speed of staging conveyor 30 as described above, packages or bags 100 are introduced to nip 74 at the desired time, typically to achieve a controlled position for improved registration. This desired time may vary depending upon the specific application and function of main conveyor 60, and would be known by those skilled in the art, after review of the present disclosure.

Further embodiments of this invention would include the use of two staging conveyor drives and sensors (one on each lateral edge of the package or bag 100) to square the package or bag 100. Similarly, a staging roller could be used instead of a staging conveyor.

Thus the several aforementioned objects and advantages are most effectively attained. Although preferred embodiments of the invention have been disclosed and described in detail herein, it should be understood that this invention is in no sense limited thereby and its scope is to be determined by that of the appended claims.

What is claimed is:

1. A staging conveyor for communicating products between an initial conveyor and a subsequent conveyor, comprising:
a lower conveyor belt traversing lower first and second rollers;
a servo, wherein the lower conveyor belt and the lower first and second rollers move operatively responsive to the servo;
a computing device controlling operation of the servo; and
a sensor for sensing a position of a product being transported by the lower conveyor belt and outputting position data to the computing device, whereby the computing device calculates a desired speed for a product and outputs data to the servo to adjust the speed of the lower conveyor belt and lower first and second rollers.

2. The staging conveyor of claim 1 wherein the staging conveyor is configured and arranged to transport products including packages or bags.

3. The staging conveyor of claim 2 further including an upper conveyor belt traversing upper first and second rollers.

4. The staging conveyor of claim 3 wherein a lower portion of the upper conveyor belt impinges against an upper portion of the lower conveyor belt whereby the upper and lower conveyor belts run at a same speed.

5. The staging conveyor of claim 4 wherein a nip is formed between the upper conveyor belt and the lower conveyor belt.

6. The staging conveyor of claim 5 wherein the nip receives the products.

7. The staging conveyor of claim 6 wherein the servo drives one of the first and second upper rollers, and whereby the lower first and second rollers and lower conveyor belt are driven by way of contact with the upper conveyor.

8. A combination of conveyors, comprising:
an initial conveyor receiving a product; and
a staging conveyor receiving a product from the initial conveyor, the staging conveyor comprising:
a lower conveyor belt traversing lower first and second rollers;
a servo, wherein the lower conveyor belt and the lower first and second rollers move operatively responsive to the servo;
a computing device controlling operation of the servo; and
a sensor for sensing a position of a product being transported by the lower conveyor belt and outputting position data to the computing device, whereby the computing device calculates a desired speed for a product and outputs data to the servo to adjust the speed of the lower conveyor belt and lower first and second rollers.

9. The conveyor combination of claim 8 wherein the initial conveyor and the staging conveyor are configured and arranged to transport products comprising packages or bags.

10. The conveyor combination of claim 9 wherein the staging conveyor further includes an upper conveyor belt traversing upper first and second rollers.

11. The conveyor combination of claim 10 wherein a lower portion of the upper conveyor belt impinges against an upper portion of the lower conveyor belt whereby the upper and lower conveyor belts run at a same speed.

12. The conveyor combination of claim 11 wherein a nip is formed between the upper conveyor belt and the lower conveyor belt.

13. The conveyor combination of claim 12 wherein the nip receives the products.

14. The conveyor combination of claim 13 wherein the servo drives one of the first and second upper rollers, and whereby the lower first and second rollers and lower conveyor belt are driven by way of contact with the upper conveyor belt.

15. A combination of conveyors, comprising:
an initial conveyor receiving a product;
a staging conveyor receiving a product from the initial conveyor, the staging conveyor comprising:
a lower conveyor belt traversing lower first and second rollers;
a servo, wherein the lower conveyor belt and the lower first and second rollers move operatively responsive to the servo;
a computing device controlling operation of the servo; and
a sensor for sensing a position of a product being transported by the lower conveyor belt and outputting position data to the computing device, whereby the computing device calculates a desired speed for a product and outputs data to the servo to adjust the speed of the lower conveyor belt and lower first and second rollers; and
a subsequent conveyor receiving a product from the staging conveyor.

16. The conveyor combination of claim 15 wherein the initial conveyor, the staging conveyor and the subsequent conveyor are configured and arranged to transport products comprising packages or bags.

17. The conveyor combination of claim 16 wherein the staging conveyor further includes an upper conveyor belt traversing upper first and second rollers.

18. The conveyor combination of claim 17 wherein a lower portion of the upper conveyor belt impinges against an upper portion of the lower conveyor belt whereby the upper and lower conveyor belts run at a same speed.

19. The conveyor combination of claim 18 wherein a nip is formed between the upper conveyor belt and the lower conveyor belt, wherein the nip receives the products from the initial conveyor.

20. The conveyor combination of claim 19 wherein the servo drives one of the first and second upper rollers, and whereby the lower first and second rollers and lower conveyor belt are driven by way of contact with the upper conveyor belt.
